(19) United States
(12) Patent Application Publication
(10) Pub. No.: US 2011/0176604 A1
(43) Pub. Date: Jul. 21, 2011

(54) TERMINAL, IMAGE DISPLAY METHOD, AND PROGRAM

(76) Inventor: Kazunon Ozawa, Tokyo (JP)

(21) Appl. No.: 13/122,260

(22) PCT Filed: Oct. 9, 2009
(86) PCT No.: PCT/JP2009/067613

§ 371 Date: Apr. 1, 2011

(30) Foreign Application Priority Data
Oct. 9, 2008 (JP) 2008-263126

(51) Int. Cl. H04N 7/32; G06K 9/36; H04N 7/24; H04N 7/26

(52) U.S. Cl. 375/240.02; 382/238; 375/E07.011; 375/E07.126; 375/E07.243

(57) ABSTRACT

A terminal comprises a reception unit that receives image data compressed by using inter-frame prediction: and a first conversion unit that converts a first predictive frame in the image data received by said reception unit or a predictive frame immediately after switching made by a user switching request into a non-predictive frame and outputs said non-predictive frame.

### REFERENCE TO RELATED APPLICATION

This application is the National Phase of PCT/JP2009/067613, filed Oct. 9, 2009, which is based upon and claims the benefit of the priority of Japanese patent application No. 2008-263126 filed on Oct. 9, 2008, the disclosure of which is incorporated herein in its entirety by reference thereto.

### TECHNICAL FIELD

The present invention relates to a terminal, image display method, and program, and particularly to a terminal comprising a function of receiving a stream in which contents including at least a moving picture or still image are encoded and compressed, image display method, and program thereof recorded on a computer readable recording medium.

### BACKGROUND

In recent years, multimedia contents including moving pictures and still images have been distributed in a network environment in addition to in 1 seg and digital terrestrial broadcasting, and IPTV (Internet Protocol Television) in which contents are watched in such an environment is widespread.

In order to reduce the load of a network, a technology that distributes contents using a multicast protocol or broadcast protocol when distributing contents via an IP network has been considered. Further, it is expected that network bandwidth will be expanded and accelerated in wired networks and mobile networks in the near future using the NGN (Next Generation Network) technology and the LTE (Long Term Evolution) mobile technology.

Patent Document 1 discloses a broadcast-transmitting server that receives television broadcast and multicasts to mobile terminals via a communication network such as a packet-switching network, the Internet, and a public line-switching network.

Patent Document 2 discloses a video transmission system that outputs a video after confirming that a video, decoded from video encoded data transmitted from at least one video encoder specified out of video encoders that start to generate video encoded data from original images in response to a video switching instruction from a video decoder, is stable, in order to reduce the duration of a frozen image occurring when a video is switched in the video transmission system.

Patent Document 3 discloses a television receiver that performs frame-rate conversion with moving picture frame interpolation on a video including a moving picture therein within a screen of one frame to be displayed, performs frame-rate conversion with no moving picture frame interpolation on an OSD (On Screen Display) picture by means of a still picture, and that suppresses deterioration of picture quality when piling up and displaying OSD pictures on the moving picture. Further, Paragraph [0016] of Patent Document 3 states that a scaling unit comprised by this television receiver converts resolution.
[Patent Document 1]
Japanese Patent Kokai Publication No. JP-P2002-185943A
[Patent Document 2]
Japanese Patent Kokai Publication No. JP-P2004-193961A
[Patent Document 3]
Japanese Patent Kokai Publication No. JP-P2008-160591A

### SUMMARY

As stated in Paragraph [0006] and later of Patent Document 2, in a method that transmits compressed and encoded images, an image may not be displayed on a receiver terminal immediately after a user has started to play a video or switched channel. Particularly, a user accustomed to analog broadcasting may feel stressed by this wait time, feeling uncomfortable with it, and may become impatient and cut off the connection.

In view of the above described status of the art, it is an object of the present invention is to provide a terminal, image display method, and program capable of eliminating the wait time upon start of viewing image data and at the time of channel switching on a terminal's end receiving various compressed and encoded images transmitted in 1 seg and digital terrestrial broadcasting, mobile networks, the Internet, and wired network and IPTV environments.

Thus, there is much to be desired in the art.

According to a first aspect of the present invention, there is provided a terminal comprising a reception unit that receives image data compressed by using inter-frame prediction according to a user request, and a first conversion unit that converts a first predictive frame in the image data received by the reception unit or a predictive frame immediately after switching made by a user switching request into a non-predictive frame and outputs said non-predictive frame.

According to a second aspect of the present invention, there is provided an image display method comprising receiving image data compressed by using inter-frame prediction according to a user request, converting a first predictive frame in the received image data or a predictive frame immediately after switching made by a user switching request into a non-predictive frame, and displaying subsequent frames with the non-predictive frame as a head frame. The image display method is tied to a terminal comprising a function of receiving a stream in which contents including at least a moving picture or still image.

According to a third aspect of the present invention, there is provided a computer readable program having a computer system execute a processing of receiving image data compressed by using inter-frame prediction in response to a display start request or channel switching request from a user according to a user request, and a processing of converting a first predictive frame in the received image data or a predictive frame immediately after switching made by a user switching request into a non-predictive frame, and displaying subsequent frames with the non-predictive frame as a head frame on a display device connected to the computer.

The meritorious effects of the present invention are summarized as follows. According to the present invention, it becomes possible to reduce a wait time for an image to be displayed upon start of viewing the image and at the time of channel switching. The reason is that, when a head frame of the received image or a frame immediately after switching is a predictive frame, the image is displayed after the predictive frame has been converted into a non-predictive frame.

### BRIEF DESCRIPTION OF THE DRAWINGS

FIG. 1 is a block diagram showing the configuration of a first exemplary embodiment of the present invention.

FIG. 2 is a flowchart for explaining the operation of the first exemplary embodiment of the present invention.

FIG. 3 is a block diagram showing the configuration of a second exemplary embodiment of the present invention.

FIG. 4 is a flowchart for explaining the operation of the second exemplary embodiment of the present invention.

FIG. 5 is a block diagram showing the configuration of a third exemplary embodiment of the present invention.

FIG. 6 is a block diagram showing the configuration of a fourth exemplary embodiment of the present invention.

### PREFERRED MODES

First, a summary of the present disclosure will be given. The present invention is applied to a terminal having a function of receiving image data compressed by using inter-frame prediction. For instance, the image data is broadcast from a broadcast station or distributed from a content server provided on a network via multicast or broadcast. Terminals receiving these contents include, for instance, an image display device or a set-top box connected to an image display device, a TV tuner, a mobile terminal comprising an image display function, a personal computer, and various information processing devices such as a car navigation terminal comprising a communication function.

A terminal relating to the present invention receives a connection request and reception request from a user and starts to receive image data from a broadcast station or content server, as described above. At this time, the terminal relating to the present invention comprises a conversion unit that converts a head frame in the received image data into a non-predictive frame and outputs said non-predictive frame. The conversion unit outputs frames other than the first frame without converting them. The terminal relating to the present invention displays the received moving picture image or still image on a predetermined display device after the conversion into the non-predictive frame. Because of this, the time it takes to actually display an image after a viewing start request from a user can be reduced greatly.

Further, when receiving a request to switch a viewed program or contents from a user, the terminal relating to the present invention displays a received moving picture image or still image on a predetermined display device after converting a frame immediately after the switching into a non-predictive frame. Because of this, the time it takes to actually display an image after switching after a switching request is received from a user can be reduced greatly.

Next, preferred exemplary embodiments of the present invention will be described in detail with reference to the drawings. First, first and second exemplary embodiments in which a function of converting the resolution of an image or improving image quality is added on the terminal's end will be described. Below, 1) the first exemplary embodiment has a configuration in which the resolution conversion or image quality improving processing is always performed, and 2) in the second exemplary embodiment, whether or not the resolution conversion or the image quality improving processing should be performed is determined by referring to predetermined parameters. The parameters may include at least one or combinations of the following: a user's instruction, a predetermined setting, a resolution of a received moving picture image or still image, the screen size, the bit rate, and the network bandwidth.

### First Exemplary Embodiment

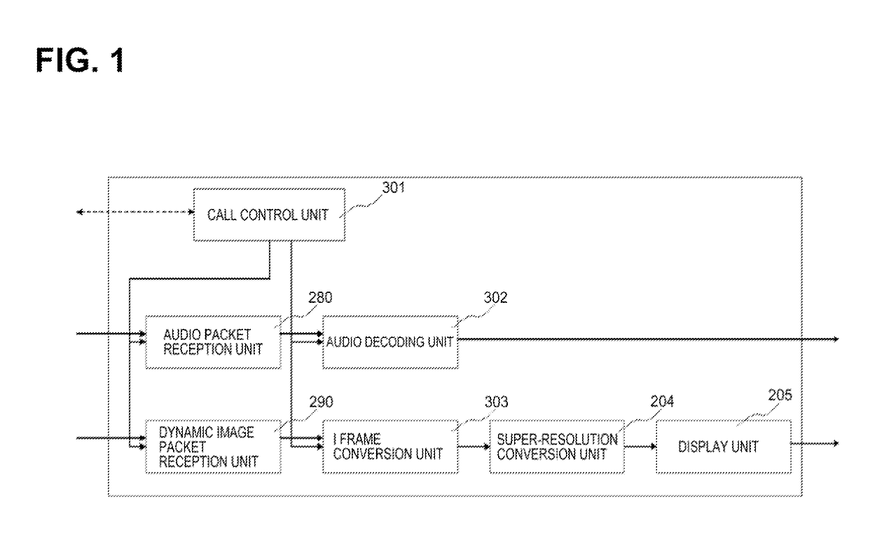

FIG. 1 is a block diagram showing the configuration of a terminal relating to the first exemplary embodiment of the present invention. FIG. 1 shows the configuration of the terminal comprising a call control unit 301, an audio packet reception unit 280, a dynamic image packet reception unit 290, an audio decoding unit 302, an I frame conversion unit 303, an super-resolution conversion unit 204, and a display unit 205. Among these, the 1 frame conversion unit 303 and the super-resolution conversion unit 204 correspond to first and second conversion units.

The terminal of the present exemplary embodiment is able to receive moving picture or still image contents via a wired network, mobile network, or the Internet. Here, we assume that the network is a packet network, however, the present exemplary embodiment can be applied to a mobile circuit-switched network.

The call control unit 301 communicates with a server distributing contents on the network according to a predetermined protocol, and requests the distribution of the contents a user has specified. More concretely, in response to a connection request, channel switching request, or content switching request from a user, the call control unit 301 exchanges a session control signal with the content server distributing contents using, for instance, RTSP (Real Time Streaming Protocol) or SIP (Session Initiation Protocol), and relays the connection request, channel switching request, or content switching request to the content server.

Further, the call control unit 301 informs the content server of the capability information of the terminal using, for instance, SDP (Session Description Protocol). SDP information received from the content server gives capability information regarding a video signal and an audio signal transmitted from the content server.

For details of SIP, RTSP, and SDP, refer to IETF RFC 3261, RFC 2326, and IETF RFC 2327, respectively.

The capability information received by the call control unit 301 is outputted to the 1 frame conversion unit 303, the audio decoding unit 302, the dynamic image packet reception unit 290, and the audio packet reception unit 280.

An example of capability information regarding audio codec is AMR (Adaptive Multi-Rate) audio codec. Details of the AMR can be found in the 3GPP TS 26.090 technical specifications.

The audio packet reception unit 280 receives an audio RTP packet from the network, reads an audio stream stored in the payload part of the RTP packet referring to the capability information regarding the audio signal received from the call control unit 301, and outputs the audio stream.

Referring to the capability information regarding the audio signal received from the call control unit 301, the audio decoding unit 302 receives the audio stream from the audio packet reception unit 280, and decodes and outputs the audio.

The dynamic image packet reception unit 290 receives a video RTP packet from the network immediately after a connection request or channel switching, reads a video stream stored in the payload part of the RTP packet, and outputs the video stream to the I frame conversion unit 303, referring to the capability information regarding the video signal received from the call control unit 301.

Referring to the capability information regarding the video signal received from the call control unit 301, the I frame conversion unit 303 temporarily decodes the video stream received from the dynamic image packet reception unit 290. Further, the I frame conversion unit 303 determines whether or not a first frame immediately after the reception is an I frame (non-predictive frame), re-encodes the first frame into an I frame when it is not an I frame, and outputs the encoded stream. When the first frame immediately after the reception is an I frame, the conversion does not take place and the received stream is outputted without any change. As for second and later frames, the I frame conversion unit 303 outputs the received stream without performing the conversion and re-encoding described above.

Here, the first frame is re-encoded into an I frame according to the capability information received from the call control unit 301. For instance, when the capability information indicates H.264 BPP@L1.2, an image resolution of QVGA, a bit rate of 384 kbps, and a frame rate of 15 fps, the I frame conversion unit 303 performs the re-encoding according to these parameters.

The super-resolution conversion unit 204 performs super-resolution process on the decoded video stream from the I frame conversion unit 303 and outputs the result to the display unit 205. For instance, a QVGA resolution can be expanded into a VGA resolution. As techniques for realizing such an super-resolution process, the following methods are proposed: (a) a method that expands resolution by increasing the number of pixels using a plurality of image frames as a reference image for a target image frame, and (b) a method that increases the number of pixels by using pixels in different areas in a target image frame. In the present invention, an optimum method can be selected within restrictions such as allocatable resources (computation amount and memory amount) for the terminal without being limited thereto.

(a) When a reference frame from the past is used, a resolution is expanded as follows. The super-resolution conversion unit 204 may be configured in such a manner that it receives a motion vector for each macroblock from a decoder in the I frame conversion unit 303, derives a more detailed motion vector by performing a search again on pixels included in each macroblock based on the received motion vector, and increases the number of pixels of a target frame by applying this detailed motion vector to pixels of the reference image frame from the past and moving only the motion vector. A configuration that does not use motion vector may be employed as well.

(b) Further, when only a target frame is used, a resolution is expanded as follows. The super-resolution conversion unit 204 improves image quality by detecting an edge and emphasizing it such as detecting an edge part and increasing pixels by applying pixels near the edge, or increasing the sense of resolution by correcting pixels near the edge.

In addition to the resolution improvement described above, the image quality can be improved as well. For instance, the frame rate can be increased by having the super-resolution conversion unit 204 interpolate frame images in the time direction by estimating a moving direction. By doing this, for instance, a video stream of 15 fps can be expanded into a video stream of 30 fps.

The display unit 205 receives a converted moving picture signal from the super-resolution conversion unit 204 and displays an image on a predetermined display device.

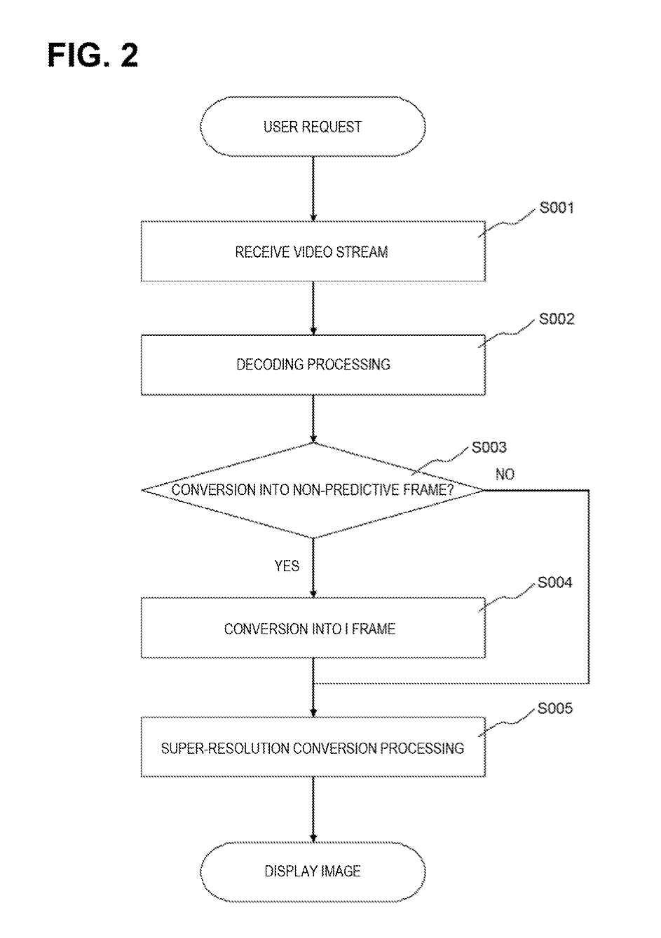

The operation of the terminal of the present exemplary embodiment will be described with reference to a flowchart in FIG. 2. When the call control unit 301 of the terminal requests delivery of contents after receiving a connection request operation, reception request operation, or channel switching request operation from a user, the content server starts to deliver contents and the dynamic image packet reception unit 290 outputs a received video stream to the I frame conversion unit 303 (step S001).

The I frame conversion unit 303 decodes the video stream received by the dynamic image packet reception unit 290 (step S002) and determines whether or not a first frame immediately after the reception is an I frame (non-predictive frame) (step S003). When the first frame is not an I frame, the I frame conversion unit 303 determines that it needs to be converted into an I frame (non-predictive frame) and converts it into a non-predictive frame (step S004).

As described, the super-resolution conversion unit 204 receives the video stream in which at least the first frame immediately after the reception is converted into a non-predictive frame. The super-resolution conversion unit 204 performs predetermined super-resolution conversion processing on the received video stream and outputs the result to the display unit 205 (step S005).

Finally, the display unit 205 displays an image based on a received video signal.

As described, according to the present exemplary embodiment, when a terminal, IPTV set top box, or TV receiver receives contents compressed by using inter-frame prediction by a user's connection request, or when contents are switched to other contents by a user's switching request, an image can be displayed instantly. As a result, a user accustomed to analog broadcasting does not feel any stress.

Further, since the present exemplary embodiment comprises the super-resolution conversion unit 204 that improves resolution and image quality, it is possible to improve the image quality when the conversion into a non-predictive frame is performed by the I frame conversion unit 303, in addition to being able to provide contents with a high image quality.

### Second Exemplary Embodiment

Next, the second exemplary embodiment of the present invention having a mechanism of determining whether or not the resolution conversion described above or image quality improving processing should be performed referring to predetermined parameters will be described in detail with reference to the drawings.

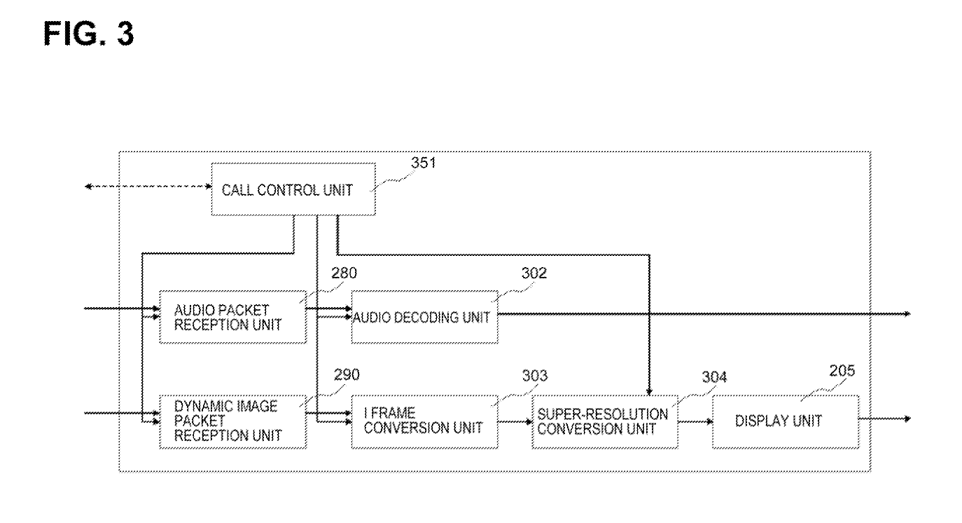

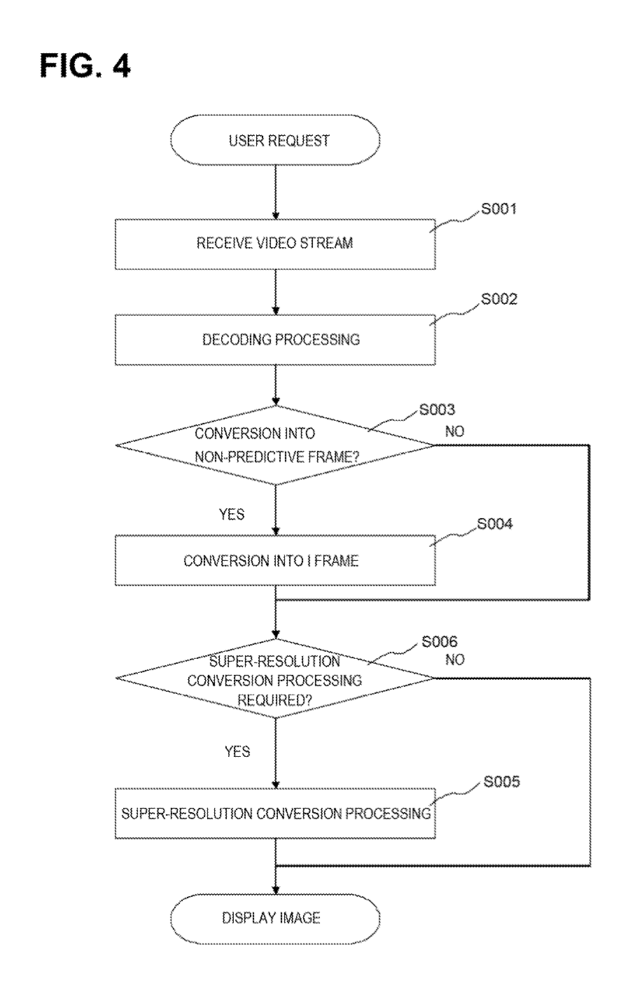

FIG. 3 is a block diagram showing the configuration of a terminal relating to the second exemplary embodiment of the present invention. FIG. 4 is a flowchart showing the operation of the terminal relating to the second exemplary embodiment of the present invention. In FIGS. 3 and 4, constituent elements given the same symbols as in FIG. 1 operate as they do in FIG. 1, thus explanations of them will be omitted. The second exemplary embodiment will be described below focusing on functions and operations (step S006 in FIG. 4) of a call control unit 351 and an super-resolution conversion unit 304.

As the call control unit 301 of the first exemplary embodiment, the call control unit 351 relays a user request to the content server and gives an ON/OFF instruction to the super-resolution conversion unit 304, indicating whether or not the super-resolution conversion processing should be performed. The ON/OFF instruction is determined based on at least one of the following two factors.

One of the factors is a ON/OFF request from a user. The other is the result obtained by the call control unit 351 from referring to the parameters of the capability information and to predetermined conditions for performing the super-resolution conversion processing (refer to the step S006 in FIG. 4).

For instance, the conditions for performing the super-resolution conversion processing may be set as follows. When the resolution and screen size is smaller than VGA, the super-resolution conversion is ON, and in any other case, it should be OFF. Further, for instance, the conditions may be set in such a manner that the super-resolution conversion is ON when the bit rate is less than 512 kbps, and it is OFF when the bit rate is at 512 kbps or more. Further, a predetermined operation condition may be set in such a manner that the conversion is ON when the I frame conversion unit 303 performs the conversion into a non-predictive frame.

Based on the instruction from the call control unit 351 indicating whether or not the super-resolution conversion processing should be performed, the super-resolution conversion unit 304 appropriately performs the super-resolution conversion processing on a decoded video stream outputted from the I frame conversion unit 303 and outputs the result to the display unit 205 (refer to step S005 in FIG. 4). For instance, when receiving an instruction indicating that the super-resolution conversion processing is ON, the super-resolution conversion unit 304 performs processing that improves the image quality while increasing the screen resolution, and outputs a converted and processed video stream to the display unit 205.

Similarly, the super-resolution conversion unit 304 may operate so that a resolution of QVGA is increased to a resolution of VGA when receiving an instruction indicating that the super-resolution conversion processing is ON.

Meanwhile, when receiving an instruction indicating that the super-resolution conversion processing is OFF, the super-resolution conversion unit 304 outputs the video stream outputted from the I frame conversion unit 303 to the display unit 205 without any change.

As described, according to the present exemplary embodiment, it becomes possible to output delivered contents while improving the resolution and image quality thereof within the capabilities of the terminal, in addition to the case where a user request is made.

### Third Exemplary Embodiment

Next, third and fourth exemplary embodiments of the present invention in which the present invention is applied to a terminal comprising a function of receiving moving picture or still image contents via 1 seg and digital terrestrial broadcasting will be described. Below, as in the first and second exemplary embodiment, (1) the third exemplary embodiment has a configuration in which the resolution conversion or the image quality improving processing is always performed, and (2) in the fourth exemplary embodiment, whether or not the resolution conversion or the image quality improving processing should be performed is determined by referring to predetermined parameters.

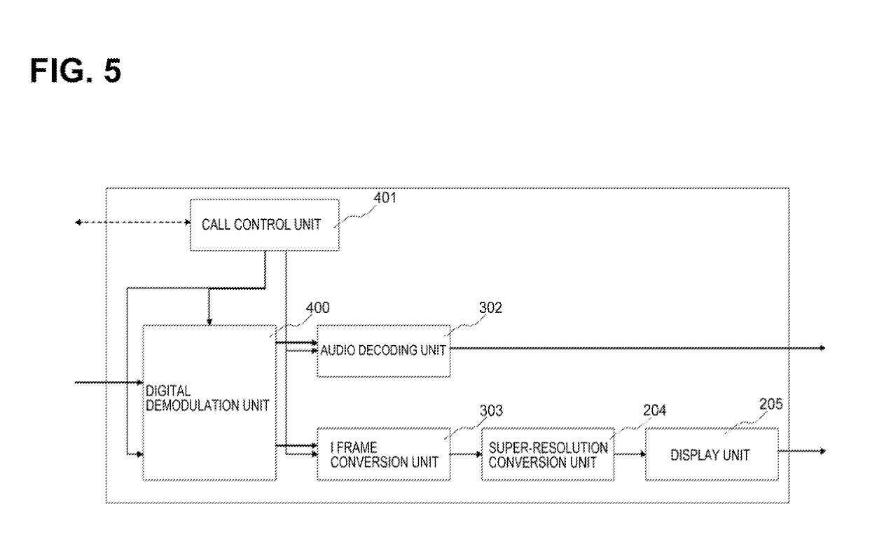

FIG. 5 is a block diagram showing the configuration of a terminal relating to the third exemplary embodiment of the present invention. In FIG. 5, constituent elements given the same symbols as in FIG. 1 operate as they do in FIG. 1, thus explanations of them will be omitted. The third exemplary embodiment will be described below focusing on functions and operations of a digital demodulation unit 400 and a control unit 401.

The digital demodulation unit 400 receives broadcast airwaves and digitally demodulates it by, for instance, OFDM (Orthogonal Frequency Division Multiplex). The digital demodulation unit 400 further performs demultiplexing into capability information, a moving picture stream, and an audio stream, and outputs the capability information to the control unit 401, the moving picture to the I frame conversion unit 303, and the audio stream to the audio decoding unit 302, respectively.

The control unit 401 outputs a reception request operation or channel switching request operation from a user to the digital demodulation unit 400.

The capability information is outputted to the I frame conversion unit 303 and the audio decoding unit 302. The I frame conversion unit 303, the audio decoding unit 302, and the super-resolution conversion unit 204 operate as in the first exemplary embodiment, respectively.

As described, the present invention can be applied to a terminal comprising a function of receiving contents over airwaves, and it becomes possible to eliminate a wait time upon start of viewing image data and at the time of channel switching and to improve the resolution and image quality.

### Fourth Exemplary Embodiment

Next, the fourth exemplary embodiment of the present invention having a mechanism of determining whether or not the resolution conversion or the image quality improving processing should be performed referring to predetermined parameters will be described in detail with reference to the drawings.

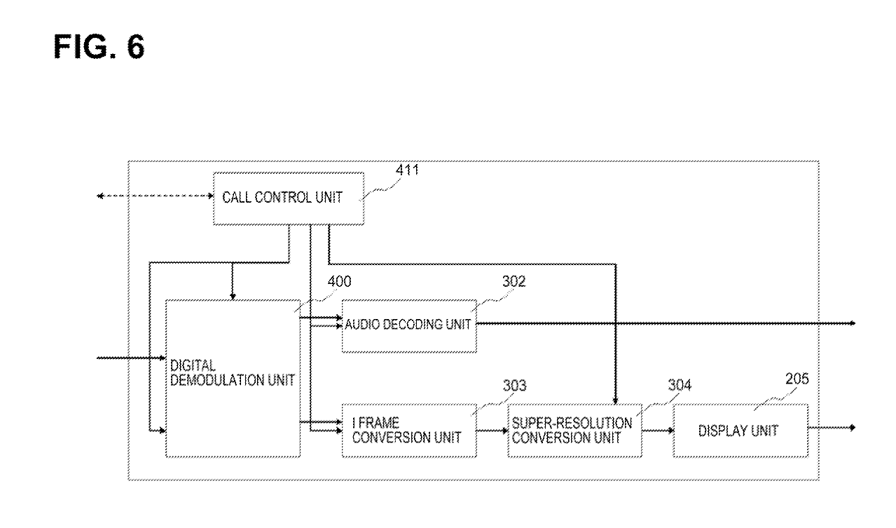

FIG. 6 is a block diagram showing the configuration of a terminal relating to the fourth exemplary embodiment of the present invention. In FIG. 6, constituent elements given the same symbols as in FIGS. 1 and 5 operate as they do in FIGS. 1 and 5, thus explanations of them will be omitted. The fourth exemplary embodiment will be described below focusing on a control unit 411 and the super-resolution conversion unit 304.

The control unit 411 outputs a connection instruction or channel switching instruction received from a user to the digital demodulation unit 400. Further, as in the third exemplary embodiment, the control unit 411 receives the capability information demultiplexed by the digital demodulation unit 400.

In addition to the above, the control unit 411 gives an ON/OFF instruction indicating whether or not the super-resolution conversion processing should be performed to the super-resolution conversion unit 304. As in the second exemplary embodiment described above, the ON/OFF instruction is determined based on parameters extracted from a user's instruction and the capability information.

As in the second exemplary embodiment, based on the instruction from the control unit 411 indicating whether or not the super-resolution conversion processing should be performed, the super-resolution conversion unit 304 appropriately performs the super-resolution conversion processing on a decoded video stream outputted from the I frame conversion unit 303 and outputs the result to the display unit 205.

The configuration described above that corresponds to the second exemplary embodiment can be applied to a terminal comprising a function of receiving contents over airwaves, and it becomes possible to output contents after improving the resolution and image quality of the contents, taking a user's instruction, the capability information, and the capability of the terminal into consideration.

The preferred exemplary embodiments of the present invention have been described, however, the present invention is not limited to the exemplary embodiments described above, and within the scope of the basic technological concepts of the present invention, further modifications, substitutions, and adjustments can be added.

For instance, the call control unit that performs C-Plane (Control-Plane) processing and the packet reception units, the conversion units, and the display unit that perform U-Plane (User-Plane) processing are assumed to be provided in a single terminal in the first and second exemplary embodiments, however, a configuration in which the C-Plane processing and the U-Plane processing are separated and assigned to different devices can be employed as well. According to this configuration, the C-Plane device and the U-Plane device can have independent scalability.

Further, in the exemplary embodiments described above, the content server stores a compressed and encoded stream into an RTP packet and distributes it to the terminal, however, the compressed and encoded stream can be stored in a file format and transmitted to the terminal using a protocol such as HTTP or TCP. Here, as a file format, for instance 3GP file format is well-known and for details thereof, refer to the 3GPP TS 26.244 standard.

Further, in the exemplary embodiments described above, the explanations are made assuming that moving picture contents are displayed, however, similar configurations can be employed for contents in which still images are switched and displayed.

Further, as a method for compressing and encoding image data, various compression encoding methods such as H.263, MPEG-4, and H.264 can be used. For instance, for details of MPEG-4, refer to the ISO/IEC 14496-2 Information Technology Coding of Audio Visual Object-Part 2: Visual standard.

Further, in the exemplary embodiments described above, multicast and broadcast environments are assumed, however, the present invention can be applied to a case where contents are distributed via unicast.

### Mode 1

In the following, preferred modes are summarized. (refer to the terminal of the first aspect).

### Mode 2

The terminal according to mode I further comprising a second conversion unit that performs resolution conversion or image quality improvement processing on an image outputted from the first conversion unit.

### Mode 3

The terminal according to mode 2, wherein the second conversion unit determines whether or not to perform the resolution conversion or image quality improvement processing according to at least one of the following parameters: a user's instruction, a predetermined setting, a resolution of a received moving picture image or still image, a screen size, a bit rate, and a network bandwidth.

### Mode 4

A terminal comprising:

a reception unit that receives image data compressed by using inter-frame prediction; and
a second conversion unit that performs resolution conversion or image quality improvement processing on an image obtained from the received image data based on at least one of the following parameters: a user's instruction, a predetermined setting, a resolution of a received moving picture image or still image, a screen size, a bit rate, and a network bandwidth.

### Mode 5

The terminal according to any one of modes 1 to 4, wherein the reception unit receives image data via airwaves, a packet network, or a line-switching network.

### Mode 6

(refer to the image display method of the second aspect)

### Mode 7

An image display method comprising:

receiving image data compressed by using inter-frame prediction according to a user request; determining whether or not to perform resolution conversion or image quality improvement processing on an image obtained from the received image data based on at least one of the following parameters: a user's instruction, a predetermined setting, a resolution of a received moving picture image or still image, a screen size, a bit rate, and a network bandwidth; and displaying an image after performing resolution conversion or image quality improvement processing according to the determining result.

### Mode 8

(refer to the computer readable program of the third aspect)

### Mode 9

A computer readable program having a computer system execute:

a processing of receiving image data compressed by using inter-frame prediction according to a user request;
a processing of determining whether or not to perform resolution conversion or image quality improvement processing on an image obtained from the received image data based on at least one of the following parameters: a user's instruction, a predetermined setting, a resolution of a received moving picture image or still image, a screen size, a bit rate, and a network bandwidth; and
a processing of performing resolution conversion or image quality improvement processing according to the determining result; and
displaying an image on a display device connected to the computer.

It should be noted that other objects, features and aspects of the present invention will become apparent in the entire disclosure and that modifications may be done without departing the gist and scope of the present invention as disclosed herein and claimed as appended herewith.

Also it should be noted that any combination of the disclosed and/or claimed elements, matters and/or items may fall under the modifications aforementioned.

### Explanation of Symbols

204, 304: super-resolution conversion unit
205: display unit
280: audio packet reception unit
290: dynamic image packet reception unit
302: audio decoding unit
303: I frame conversion unit
301, 351: call control unit
400: digital demodulation unit
401, 411: control unit

What is claimed is:

1. A terminal comprising:
a reception unit that receives image data compressed by using inter-frame prediction; and
a first conversion unit that converts a first predictive frame in the image data received by said reception unit or a predictive frame immediately after switching made by a user switching request into a non-predictive frame and outputs said non-predictive frame.

2. The terminal according to claim 1, further comprising a second conversion unit that performs resolution conversion or image quality improvement processing on an image outputted from said first conversion unit.

3. The terminal in according to claim 2, wherein said second conversion unit determines whether or not to perform said resolution conversion or image quality improvement processing according to at least one of the following parameters: a user's instruction, a predetermined setting, a resolution of a received moving picture image or still image, a screen size, a bit rate, and a network bandwidth.

4. A terminal comprising:
a reception unit that receives image data compressed by using inter-frame prediction; and
a second conversion unit that performs resolution conversion or image quality improvement processing on an image obtained from said received image data based on at least one of the following parameters: a user's instruction, a predetermined setting, a resolution of a received moving picture image or still image, a screen size, a bit rate, and a network bandwidth.

5. The terminal according to claim 1, wherein said reception unit receives image data via airwaves, a packet network, or a line-switching network.

6. An image display method comprising:
receiving image data compressed by using inter-frame prediction according to a user request;
converting a first predictive frame in said received image data or a predictive frame immediately after switching made by a user switching request into a non-predictive frame; and
displaying subsequent frames with said non-predictive frame as a head frame.

7. An image display method according to claim 6, wherein instead of said converting and said displaying, comprising:
determining whether or not to perform resolution conversion or image quality improvement processing on an image obtained from said received image data based on at least one of the following parameters: a user's instruction, a predetermined setting, a resolution of a received moving picture image or still image, a screen size, a bit rate, and a network bandwidth; and
displaying an image after performing resolution conversion or image quality improvement processing according to said determining result.

8-9. (canceled)

10. The terminal according to claim 2, wherein said reception unit receives image data via airwaves, a packet network, or a line-switching network.

11. The terminal according to claim 3, wherein said reception unit receives image data via airwaves, a packet network, or a line-switching network.

12. The terminal according to claim 4, wherein said reception unit receives image data via airwaves, a packet network, or a line-switching network.

13. The image display method according to claim 6, further comprising:
performing resolution conversion or image quality improvement processing on an image obtained from said received image data.

14. The image display method according to claim 13, further comprising:
determining whether or not to perform said resolution conversion or said image quality improvement processing based on at least one of the following parameters: a user's instruction, a predetermined setting, a resolution of a received moving picture image or still image, a screen size, a bit rate, and a network bandwidth.
